(19) United States
(12) Patent Application Publication
(10) Pub. No.: US 2011/0062802 A1
(43) Pub. Date: Mar. 17, 2011

(54) METHODS AND SYSTEMS FOR A MAGNETIC-ACTIVATED PISTON DRIVEN PROPULSION SYSTEM NOT REQUIRING AN INTERNAL-COMBUSTION PROCESS

(75) Inventor: Charles W. KELLUM, Alexandria, VA (US)

(73) Assignee: GALACTICAN GROUP, Alexandria, VA (US)

(21) Appl. No.: 12/881,106

(22) Filed: Sep. 13, 2010

Related U.S. Application Data
(60) Provisional application No. 61/241,469, filed on Sep. 11, 2009.

(51) Int. Cl. H02K 7/075

(52) U.S. Cl. 310/20

(57) ABSTRACT

A common V-8 type internal-combustion engine, of the type in wide use by today's automotive and nautical industries, is modified to operate with magnetic fields instead of internal-combustion. The internal-combustion process is eliminated, along with engine components required for the internal-combustion process. This can reduce engine size and weight. The pistons of such a modified V-8 type engine are driven by magnetic fields which are aligned by the control system of the modified V-8 type engine. The engine and control system are powered by electrical energy derived directly from spacetime. This electrical energy is produced using principles of Evans-Cartan-Einstein (ECE)-Theory to achieve spin-connection-resonance (SCR), thus amplifying the potential energy of spacetime. The resulting amplified potential energy is feed (as electrical energy) to the modified V-8 engine. Thus, this type of engine does not require gasoline type fuel, generates no exhaust, has a renewable power source, and a near zero environmental footprint.

### 1. BACKGROUND OF INVENTION

### Field of Invention

The general area of technology is well defined in patent application

Methods & Systems for Powering a Geodesic-Fall Propulsion System Thru Use of Spacetime Torsion by Charles W. Kellum

The entire teachings of which are incorporated herein by reference.

This invention relates to methods and systems for replacing internal-combustion processes with magnetic activation. A V-8 type internal-combustion engine is modified to be magnetic-activated, wherein magnetic fields are used to drive pistons.

Eliminating the internal-combustion process removes the need for gasoline type fuel, and the problem of exhaust from the internal-combustion process. Such a magnetic-activated V-8 type engine can run pollution free, and gasoline independent. It can be powered directly from spacetime thru the use of Evan-Cartan-Einstein (ECE)-Theory and spin-connection-resonance (SCR).

Deriving energy (e.g. electric power) directly from spacetime utilizes the properties of spacetime termed curvature and torsion. Torsion can be viewed as a form of curvature. Torsion can be defined as spin, thus curvature and spin are properties of spacetime. Gravitation is the curvature of spacetime. Electromagnetism is the torsion (i.e. spinning) of spacetime. Fundamentally, two charged bodies of mass will exert a gravitational attraction on each other, and have a spin connection. These properties are expressed in Cartan Geometry, which can be viewed as a “generalization” (i.e. expansion) of the Riemann Geometry used in Einstein's Theory of Relativity. A single body will be affected by both gravitation and torsion (i.e. the curvature and the spinning of spacetime), acting on said body. While geodesic-fall uses electromagnetism to induce spacetime curvature, this invention uses electromagnetism to amplify (via resonance) the effect of spacetime spin (i.e. torsion).

At resonance, the force (Newtonian force) induced by the electromagnetic field (i.e. spin) interaction between the body and spacetime, is amplified. This force can be regarded as a field, expressed in spacetime potential 0, and measured in volts. This resonance is termed spin-connection-resonance (SCR) in the (Cartan Geometry based) Evans-Cartan-Einstein Theory. The amplified 0 is used to power the magnetic-activated V-8 type engine.

### 2. SUMMARY OF INVENTION

The principles of Geodesic-Fall propulsion and ECE-theory can be applied to piston type engines. These principles will enable piston engines to operate without an internal-combustion process and thus without gasoline type fuel. These factors are illustrated, in this application, for a V-8 type configuration of a piston engine.

### 2.1 Generic Concepts

We start by considering the Coulomb Law under ECE-Theory. We have:

∇·E=ρ/∈₀
Where:

E=−∂A/∂t−∇φ−ω₀A+ωφ

∇·(−∂A/∂t−∇φ−ω₀A+ωφ)=ρ/∈₀

In spherical coordinates we have the resonance equation:

d²φ/dr²+(1/r−ωᵢₙₜ)dφ/dr−(1/r²+ωᵢₙₜ/r)φ=−ρ/∈₀
Where; ωᵢₙₜ→the interaction spin connection
   Considering the Poisson equation {∇²φ=−ρ/∈₀} of the Standard Model, and introducing the vector spin connection ω of the ECE-Theory, one has the following:

∇·(∇φ+ωφ)=−ρ/∈₀

The ECE Poisson equation

∇²φ+ω·∇φ+(∇·ω)φ=−ρ/∈₀

This equation has resonance solutions. From the ECE-Theory, it is shown that the gravitational field curves spacetime. It is also shown that the electromagnetic field curves spacetime, but by spinning spacetime. Considering φ, measured in voltage, as the spacetime potential, it is clear that φ is amplified at resonance. At resonance, the force (Newtonian force) induced by the electromagnetic field interaction between a body (e.g. mass) and spacetime, is amplified. One can regard this force in terms of a field. This field can be expressed in terms of spacetime potential φ. The effect of this amplification can be viewed in two ways. It can be viewed as a counter-gravity mechanism. It can be viewed as an electric power source.

Viewed as a counter-gravity mechanism, one considers the interaction of two charged bodies of mass [symbol] and [symbol] respectively. The total potential energy is then

φ_{Tot}=φₑ+ [symbol] +φᵢₙₜ
Where: φₑ→is the electric potential
   [symbol] →is the gravitational potential
   φᵢₙₜ→is the interaction energy between [symbol] & [symbol]
      At resonance, φ_{Tot} is greatly amplified, thus φᵢₙ is amplified. This can cause φₑ (the electric potential) to overcome [symbol] gravitational potential). This phenomenon can be interpreted as induced “negative” curvature, where “positive” curvature is interpreted to be the natural curvature of spacetime. The result is anti-gravitational effects. The Levitron device, and the Geodesic-Fall concept are examples of such induced spacetime curvature.

From the viewpoint of electric power generation, the amplified φ_{Tot} can be tapped to bleed-off excess electric energy. Arguably, this amounts to a continuously available power source, directly from spacetime. This electric energy could be used to power the electromagnetic sources M₁ and M₂ of a geodesic-fall propulsion system process. For some applications, of the geodesic-fall propulsion system, additional electromagnetic sources Mₚ₁ and Mₚ₂ could be used solely for power generation. The Mₚ₁ and Mₚ₂ (power generation) sources could also be implemented as arrays of electromagnetic elements. Thus they would also have the flexibility to enable counter-rotating magnetic fields, in order to produce the most efficient driving functions to achieve the desired resonance (SCR) effects. It is important to note that, from the engineering/implementation perspective, an array structure (of electromagnetic elements) permitting “virtual rotation” of the magnetic fields, eliminates mechanical issues involved in physically rotating a magnetic device, especially a large device.

Given the resonance equation, also equation:

√²φ+ω·∇φ+(∇·ω)φ=−ρ/∈₀

An equivalent RLC circuit can be defined. To analyze such a circuit, the following equation can be used:

L dq/dt²+R dq/dt+q/c=∈₀ cos ωt
Where: ω≈R
   ∇·ω≈1/c
   q≈φ
      As shown above, if the damping term (R dq/dt) is eliminated, resonance occurs when;

ω=(LC)^{-1/2}

then q>∞. For circuits such as this, proper adjustment of the capacitance can achieve resonance. Generally, the amplified φ, fed into a magnetic-activated V-8 type system, can act as a power source.

The primary function of such a control subsystem is to regulate the amount of amplified φ that is fed to said magnetic-activated V-8 type system. Selected tapping points can include an adjustable filter device/system to control the amount of tapped energy transferred to the propulsion system.

### 2.2 Prior Art

A type of internal-combustion engine in wide use today is the V-8 engine. It is configured with two banks of 4-cylinders each, mounted on a crankcase. The two banks of cylinders are mounted at approximately right angles to each other. The crankcase houses the common crankshaft to which all 8 cylinders are connected, each by its individual connecting-rod. For other configurations of this type engine, the two cylinder banks each contain 1, 2, 3, 5, 6 etc. cylinders, realizing a V-2, V-4, V-6, V-10, V-12, . . . V-(2i) configuration, respectively.

The top of each cylinder holds the combustion-chamber and combustion-chamber components including intake-valve, exhaust-valve, spark plug. The combustion-chamber is eliminated in the magnetic-activated V-8 (i.e. V-(2i)) type engine. Thus gasoline dependence, exhaust pollution, and other environmentally harmful factors involved in operation of internal-combustion engines, are eliminated.

### 3. BRIEF DESCRIPTION OF DRAWINGS

FIG. 1 Prior Art: 4-Pistons plus crankshaft and flywheel

FIG. 2 Prior Art: Single piston & cylinder

FIG. 3 Magnetic-Activated Piston

FIG. 4 Magnetic-Activated V-i Engine

### 4. DETAILED DESCRIPTION OF INVENTION

The invention has several fundamental embodiments which are described in the following sections. Other embodiments are derived from these fundamental embodiments.

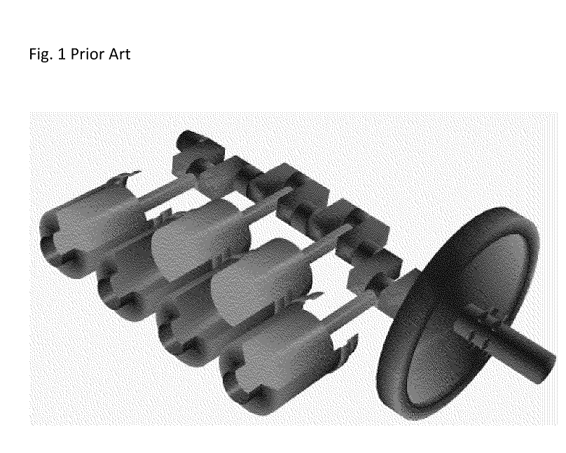

Regarding FIG. 1, one side (i.e. 4 cylinders) of a conventional V-8 type engine configuration is illustrated. Each cylinder contains a piston, a combustion-chamber, and combustion-chamber components. Each piston has a connecting-rod which connects the to the engine's crankshaft. The flywheel is used to reduce pulsation due to the piston cycles. The flywheel acts as a storage device for rotational energy, thus optimizing the energy transfer from the engine to its load.

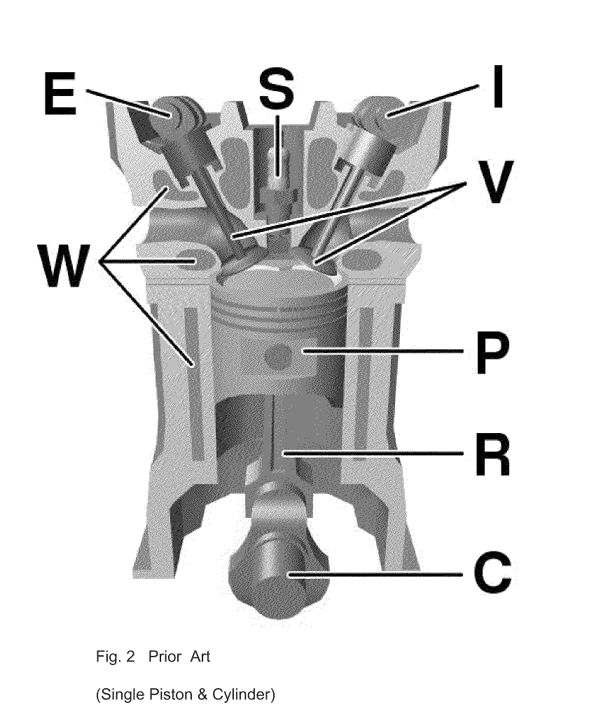

Regarding FIG. 2, a conventional single piston configuration is illustrated. The combustion-chamber components:
Exhaust camshaft (E)
Sparkplug (S)
Intake camshaft (I)
Valves (V)
Water jackets (W)
   can all be eliminated in the magnetic-activated piston engine. No gasoline (or other type of organic fuel) is required. Thus, no fuel injection process is required, and thus no combustion-chamber is needed.

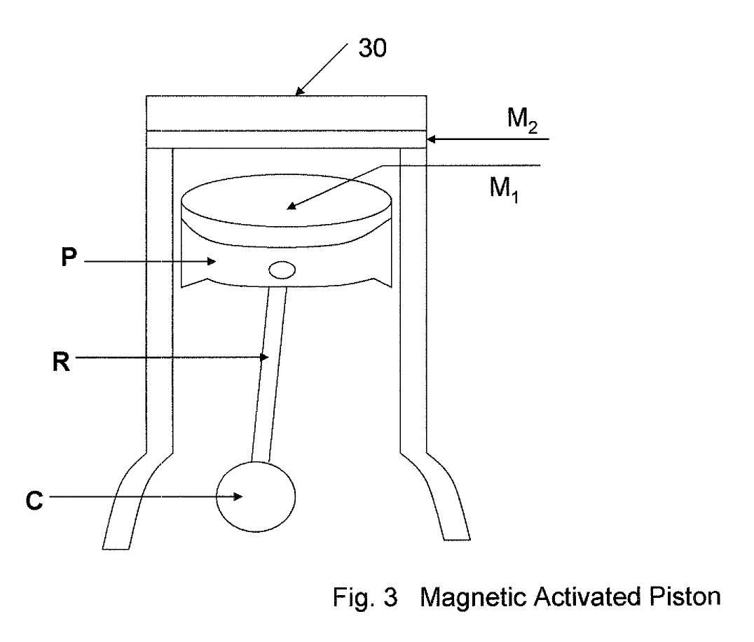

Regarding FIG. 3, a single magnetic-activated piston configuration is shown. The combustion-chamber is replaced by magnetic device M₁ and electromagnetic device M₂ which interact to produce a piston cycle.

The up-stroke of the piston (P) is initiated be setting polarity of M₂ (to cause an attraction between M₂ and M₁), or by rotation of the crankshaft (C), as in a conventional V-8 type engine configuration, if multiple cylinders are used. The connecting-rod (R), which connects the piston (P) to the crankshaft (C), is structured as in a conventional V-8 type engine.

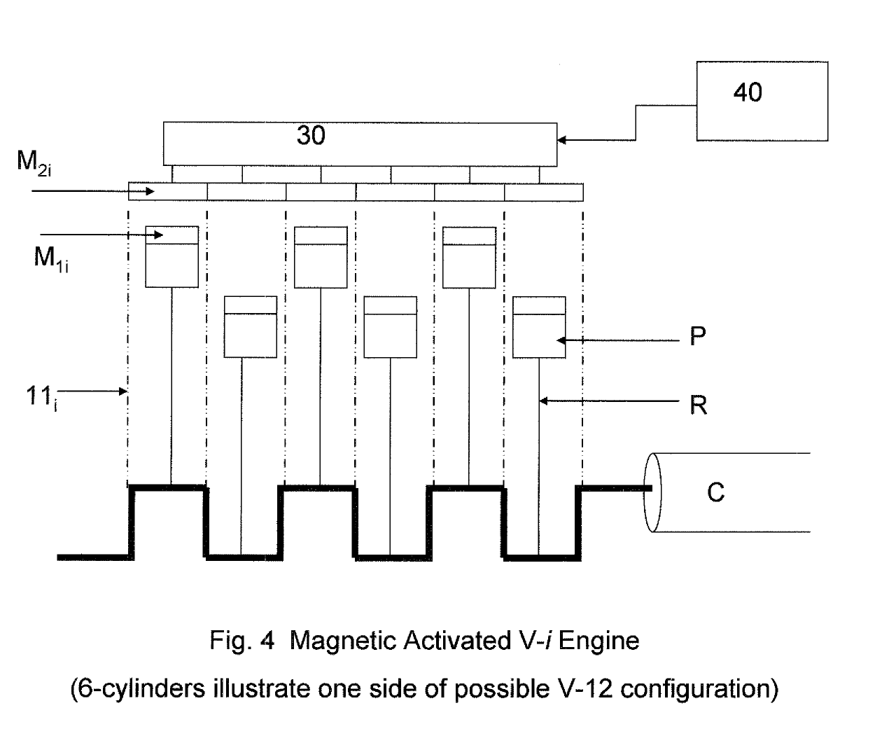

Regarding FIG. 4, modified cylinders and pistons are illustrated. Six cylinders (and their pistons) are shown, as one side (of a V-8 type configuration) for a V-12 structure engine. The combustion-chamber system on top of each cylinder (11ᵢ) is replaced by an electromagnet (M₂ᵢ). Each piston (P) has a standard magnet (M₁ᵢ), on its top. The electromagnets (M₂ᵢ) have on-off states (i.e. firing sequences) that are governed by the control system (30). Electromagnets (M₂ᵢ) react with the standard magnets (M₁ᵢ) on top of each piston (P), as follows;
In cylinder i, an activated (M₂ᵢ) repels (M₁ᵢ), which causes piston (P) in cylinder (i+1) to rise, due to the crankshaft (6) configuration. Subsequent activation of (M₂₍ᵢ₊₁₎) causes a repulsive force between (M₂₍ᵢ₊₁₎) and (M₁₍ᵢ₊₁₎) in cylinder (11₍ᵢ₊₁₎), causing the piston (P) in cylinder (11₍ᵢ₊₁₎) to down-stroke and the piston in cylinder (11ᵢ) to rise, due to the crankshaft (6) configuration. This process defines an engine cycle for the magnetic-activated V-8 type engine.
   The piston motion rotates the crankshaft (6) as in a conventional V-8 type engine. The crankshaft (including flywheel) design, can be optimized in the same manner as for a conventional V-8 type engine.

A distinct advantage of this type engine configuration is scalability. By adjusting the number of cylinders (e.g. 2×6=V-12, 2×4=V-8, 2×3=V-6) the size and power of such an engine can be selected. Further, adjustment of the field strength of the magnetic devices (M₁ᵢ), (M₂ᵢ) and activation/deactivation of cylinders (by keeping members of the set of the (M₂ᵢi) electromagnetic devices in an off-state throughout a cycle) can also dynamically control engine power.

The structure and operation of the power unit device (40), is fully described in patent application;

Methods & Systems for Powering a Geodesic-Fall Propulsion System Thru Use of Spacetime Torsion by Charles W. Kellum

The entire teachings of which are incorporated herein by reference.

The power unit (40) controls & maintains electric energy to the control unit (30).
The basic structure of the power unit does not include a dielectric slab. This basic structure is used for anti-gravity type applications. The version of the device (40) that includes a dielectric slab is used for electric power generation, and termed “The Eckardt Device version” after Dr. Horst Eckardt, (Director of the AIAS), who derived the electric energy generation concept used in this device version (40). Device (40), via the control device (30), enables the electronic-activated V-8 engine to be powered directly from spacetime. This eliminates the use of internal-combustion, and solves the environmental issues inherent with internal-combustion use.

It is expected that the present invention and many of its attendant advantages will be understood from the forgoing description and it will be apparent that various changes may be made in form, implementation, and arrangement of the components, systems, and subsystems thereof without departing from the spirit and scope of the invention or sacrificing all of its material advantages, the forms hereinbefore described being merely preferred or exemplary embodiments thereof.

The foregoing description of the preferred embodiment of the invention has been presented to illustrate the principles of the invention and not to limit the particular embodiment illustrated. It is intended that the scope of the invention be defined by all of the embodiments encompassed within the following claims and their equivalents.

What is claimed:

1. A method for powering a piston based engine, which eliminates the requirement for internal-combustion for internal-combustion by substituting an electromagnetic energy based process, in place of an internal-combustion process, wherein the piston-driving force generated by said internal-combustion process is replaced by a piston-driving force generated by application of electromagnetic fields, wherein the process of generating said piston-driving force, by application of electromagnetic fields, does not require fuel, fuel-injection, or atmospheric gases, all of which are required for an internal-combustion type process.

2. The method of claim 1, wherein said force generated by application of electromagnetic fields can be an anti-gravity type force, such as a mag-lev type force, wherein the anti-gravity/gravity-neutralization process replaces the internal-combustion process while producing the same mechanical energy as the replaced internal-combustion process would be capable of producing.

3. The method of claim 2, wherein said force generated by application of electromagnetic fields is used, in lieu of a combustion-chamber type process, to drive piston motion in a piston type engine, wherein said pistons are attached to the crankshaft of said piston type engine, whereby said crankshaft converts the piston motion into rotation type motion that is used to power a device or system such as a vehicle.

4. A system for driving piston motion in a piston type engine, which eliminates the requirement for internal-combustion by substituting an electromagnetic energy based process, in place of an internal-combustion process, wherein the piston-driving force generated by said internal-combustion process is replaced by a piston-driving force generated by application of electromagnetic fields, wherein the process of generating said piston-driving force, by application of electromagnetic fields, does not require fuel, fuel-injection, or atmospheric gases, all of which are required for an internal-combustion type process.

5. The system of claim 4, wherein said piston type engine is a V-8 type engine with the combustion-chambers, fuel intake, and exhaust mechanisms are removed, and replaced with an electromagnetic energy based process to drive the pistons, wherein the cylinders containing said pistons in said V-8 type engine house the control mechanisms for the electromagnetic piston-driving force, wherein each piston is magnetized in such manner as to optimize its response to said electromagnetic piston-driving force, wherein said control mechanism governs the activation/deactivation of the piston-driving force, wherein said electromagnetic energy based piston-driving force mechanism consists of a magnetic device to control piston motion and a control mechanism to activate/deactivate said magnetic device.

6. The system of claim 4, wherein said electromagnetic energy based process is powered by spacetime amplified electric energy thru the application of spin-connection-resonance (SCR), wherein devices producing SCR can replace the conventional battery function in a vehicle/craft, wherein such SCR producing devices are available and whereby employing SCR utilizes spacetime torsion.

7. The system of claim 5, wherein said control mechanism for said electromagnetic piston-driving force consists of a computer-controlled device which can sequentially or selectively activate/deactivate a piston-driving force in a cylinder containing a piston, in such manner as to optimize the operation of said V-8 type engine, whereby said control mechanism is powered by amplified electric energy from spacetime thru the application of spinconnection-resonance (SCR).

8. The system of claim 5, wherein a V-8 type configuration is expanded to a V-12 configuration, illustrating the scalability of this type engine configuration, wherein said engine configuration can be adjusted including dynamically adjusted by activating/deactivating in-place cylinders in power by adjusting the number of cylinders and/or the strength of the magnetic devices M2i and M1i of the cylinders, wherein adjustment of the magnetic device strength and/or the number of cylinders could reduce the engine size requirement for a given engine power requirement, whereby crankshaft design can be optimized using the same principles as are used for crankshaft design for conventional V-8 type engines.
